(19) United States
(12) Patent Application Publication
(10) Pub. No.: US 2007/0295454 A1
(43) Pub. Date: Dec. 27, 2007

(54) Reworkable compositions and methods for use thereof

(76) Inventors: Maury Edwards, Hacienda Heights, CA (US); Dan Tappendorf, Encinitas, CA (US)

Correspondence Address: Kevin Forrestal Advanced Applied Adhesives, 10080 Willow Creek Road, San Diego, CA, 92131, US

(21) Appl. No.: 11/450,704

(22) Filed: Jun. 9, 2006

(51) Int. Cl. B29C 63/00; B32B 27/38; C08L 63/00

(52) U.S. Cl. 156/344; 428/413; 156/330; 525/523

(57) ABSTRACT

The invention is based on the discovery that certain chain-extending resins can be incorporated into compositions whose physical integrity is dependent upon the temperature conditions to which the compositions are exposed. The compositions do not chemically decompose upon exposure to elevated temperatures. Instead, due to the relatively low crosslink density of the compositions, when stress is applied to the compositions at elevated temperature the compositions lose physical integrity, essentially crumbling into a powdery substance. Thus, when an invention composition is used, for example, as an underfill reinforcement for a device soldered to a board, the device can be readily removed from the board at elevated temperature simply by applying stress to the underfilled assembly.

### FIELD OF THE INVENTION

The present invention relates generally to adhesive compositions for use in the electronic packaging industry. In particular, the present invention relates to reworkable thermoset resins

### BACKGROUND OF THE INVENTION

Adhesive compositions, both conductive and electrically insulating, are used for a variety of purposes in the fabrication and assembly of semiconductor packages and microelectronic devices. The more prominent uses include bonding of electronic elements such as integrated circuit chips to lead frames or other boards, and bonding of circuit packages or assemblies to printed wire boards. Adhesives useful for electronic packaging applications typically exhibit properties such as good mechanical strength, curing properties that do not affect the component or the carrier, and thixotropic properties compatible with application to microelectronic and semiconductor components.

When a semiconductor chip is connected to a board, electrical connections are made between electrical terminations on the chip and corresponding electrical terminations on the board. One method for making these connections uses metallic or polymeric material that is applied in bumps (e.g., solder bumps) to the chip or board terminals. The solder bumps are aligned and placed in contact and the resulting assembly heated to reflow the metallic or polymeric material and solidify the connection. To prevent failure, the gap between, for example, a component and a printed wiring board is filled with a polymeric material, usually referred to as an underfill, to reinforce the interconnect and to absorb some of the stress of mechanical shock.

The underfill encapsulation may take place after the reflow of the metallic or polymeric interconnect, or it may take place simultaneously with the reflow. If underfill encapsulation takes place after reflow of the interconnect, a measured amount of underfill encapsulant material will be dispensed along one or more peripheral sides of the electronic assembly and capillary action within the component-to-board gap draws the material inward. The board may be preheated if needed to achieve the desired level of encapsulant viscosity for the optimum capillary action. After the gap is filled, additional underfill encapsulant may be dispensed along the complete assembly periphery to help reduce stress concentrations and prolong the fatigue life of the assembled structure. The underfill is subsequently cured to reach its optimized final properties.

If underfill encapsulation is to take place simultaneously with reflow of the solder or polymeric interconnects, the underfill, which can include a fluxing agent if solder is the interconnect material, first is applied to either the printed wiring board (PWB) or the component; then terminals on the component and PWB are aligned and contacted and the assembly heated to reflow the metallic or polymeric interconnect material.

For single chip packaging involving high volume commodity products, a failed chip can be discarded without significant loss. However, it becomes expensive to discard multi-chip packages with only one failed chip and the ability to rework the failed component would be a manufacturing advantage. Thus, there is a need within the semiconductor industry for reworkable underfill materials that will meet all the requirements for reinforcement of the electrical interconnect.

### SUMMARY OF THE INVENTION

The invention is based on the discovery that certain crosslinking resins can be incorporated into compositions whose physical integrity is dependent upon the temperature conditions to which the compositions are exposed. The compositions do not chemically decompose upon exposure to elevated temperatures. Instead, due to the relatively low crosslink density of the compositions, when stress is applied to the compositions at elevated temperature the compositions lose physical integrity, essentially crumbling into a powdery substance. Thus, when an invention composition is used, for example, as an underfill reinforcement for a device soldered to a printed wiring board (“board” or “PWB”), the device can be readily removed from the board at elevated temperature simply by applying stress to the adhesive. Accordingly, invention compositions are reworkable compositions.

However, in the example set forth above, if a stress is not applied to the invention composition at elevated temperature, the composition does not form a powder and the device remains adhered to the board. Upon lowering the temperature to appropriate levels, the composition regains physical integrity and the device is once again rigidly affixed to the board, and generally can not be removed upon application of stress. Thus, invention compositions can be repeatedly cycled through temperature profiles and reworked as many times as necessary depending on the particular application.

In one embodiment of the invention, there are provided reworkable compositions including a polyfunctional crosslinking resin and a monofunctional chain-extending diluent, wherein the composition is reworkable through loss of physical integrity when exposed to temperature conditions in excess of those used to cure the composition, and wherein the composition regains physical integrity when exposed to temperatures no greater than temperatures used to cure the composition.

In another embodiment of the invention, there are provided reworkable underfill compositions including a polyfunctional epoxy resin, a monofunctional epoxy diluent, and a catalyst, wherein the underfill composition is reworkable through loss of physical integrity when exposed to temperature conditions in excess of those used to cure the composition, and wherein the composition regains physical integrity when exposed to temperatures no greater than temperatures used to cure the composition.

### DETAILED DESCRIPTION OF THE INVENTION

It is to be understood that both the foregoing general description and the following detailed description are exemplary and explanatory only and are not restrictive of the invention claimed. As used herein, the use of the singular includes the plural unless specifically stated otherwise. As used herein, “or” means “and/or” unless stated otherwise. Furthermore, use of the term “including” as well as other forms, such as “includes,” and “included,” is not limiting. The section headings used herein are for organizational purposes only and are not to be construed as limiting the subject matter described.

### Definitions

Unless specific definitions are provided, the nomenclatures utilized in connection with, and the laboratory procedures and techniques of analytical chemistry, synthetic organic and inorganic chemistry described herein are those known in the art. Standard chemical symbols are used interchangeably with the full names represented by such symbols. Thus, for example, the terms “hydrogen” and “H” are understood to have identical meaning. Standard techniques may be used for chemical syntheses, chemical analyses, and formulation.

As used herein, “crosslinking,” refers to the attachment of two or more polymer chains by bridges of an element, a molecular group, or a compound. In general, chain-extending of the compositions of the invention takes place upon heating.

As used herein, “polyfunctional” means that a resin or compound contains at least two polymerizable moieties. In some embodiments of the invention, the term “polymerizable moiety” refers to a moiety having at least one unit of unsaturation that is capable of participating in a polymerization reaction. Typically, the unit of unsaturation is a carbon-carbon double bond. In other embodiments of the invention, the term “polymerizable moiety” refers to a ring-opening moiety, such as, for example, epoxy, oxetane, oxazoline, benzoxazine, and the like.

As used herein, “monofunctional” means that a resin or compound contains one polymerizable moiety.

As used herein, the phrase “loss of physical integrity”, when referring to an invention composition, means that when stress is applied to the composition, the composition essentially crumbles, forming a powder and thereby losing the ability to adhere a device to a board. As a result, the device is easily removed from the board.

As used herein, the phrase “regains physical integrity”, when referring to an invention composition, means that when stress is applied to the composition, the composition does not crumble, and does not essentially form a powder. Thus, when an invention composition regains physical integrity, a device adhered to a board with the composition can not be easily removed from the board.

As used herein, the term “acrylate” refers to a compound bearing at least one moiety having the structure:

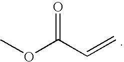

As used herein, the term “methacrylate” refers to a compound bearing at least one moiety having the structure:

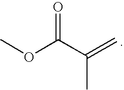

As used herein, the term “maleimide” refers to a compound bearing at least one moiety having the structure:

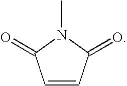

As used herein, the term “epoxy” refers to a compound bearing at least one moiety having the structure:

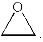

As used herein, the term “vinyl ether” refers to a compound bearing at least one moiety having the structure:

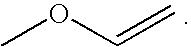

As used herein, the term “acrylamide” refers to a compound bearing at least one moiety having the structure:

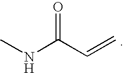

As used herein, the term “methacrylamide” refers to a compound bearing at least one moiety having the structure:

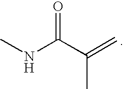

As used herein, the term “oxazoline” refers to a compound bearing at least one moiety having the structure:

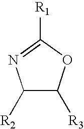

wherein R₁, R₂, and R₃ are each independently —H, alkyl, alkoxy, or aryl.

As used herein, the term “benzoxazine” refers to a compound bearing at least one moiety having the structure:

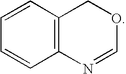

As used herein, “alkyl” refers to straight or branched chain hydrocarbyl groups having from 1 up to about 100 carbon atoms. Whenever it appears herein, a numerical range, such as “1 to 100” or “C₁-C₁₀₀”, refers to each integer in the given range; e.g., “C₁-C₁₀₀ alkyl” means that an alkyl group may comprise only 1 carbon atom, 2 carbon atoms, 3 carbon atoms, etc., up to and including 100 carbon atoms, although the term “alkyl” also includes instances where no numerical range of carbon atoms is designated.

As used herein, the term “alkoxy” refers to a moiety having the structure —O-alkyl.

In one embodiment of the invention, there are provided reworkable compositions including a polyfunctional crosslinking resin and a monofunctional chain-extending diluent, wherein the composition is reworkable through loss of physical integrity when exposed to temperature conditions in excess of those used to cure the composition, and wherein the composition regains physical integrity when exposed to temperatures no greater than temperatures used to cure the composition. In some embodiments of the invention, these compositions are employed as underfill compositions.

In some embodiments, the polyfunctional crosslinking resin and the monofunctional chain-extending diluent are each independently itaconate, maleimide, acrylate, methacrylate, epoxy, vinyl ester, vinyl ether, styrenic, maleate, fumarate, oxazoline, benzoxazine, and the like.

Without wishing to be bound by theory, it is believed that the reworkability of invention compositions arises due to the relatively low crosslink density of the compositions, when compared to conventional thermosetting resins. Thus, judicious choice and amount of monofunctional chain-extending diluent results in optimum reworkability. For example, the percentage of monofunctional chain-extending diluent can be increased, thereby decreasing the crosslink density of the composition, until the optimum reworkability properties are achieved.

Invention compositions typically lose physical integrity at a temperature of at least 180° C. In some embodiments, invention compositions typically lose physical integrity at a temperature of at least 200° C.

However, it is to be understood that a device adhered to a board remains adhered to the board even at these elevated temperatures, unless and until stress is applied to the composition. For example, if a semiconductor component is adhered to a board using an invention composition, and then subjected to temperatures of at least 180° C., the component remains adhered to the board until an attempt is made to remove it. At these elevated temperatures, the component can be removed easily since an attempt to remove the component stresses the composition, and the composition crumbles, essentially forming a powder.

This phenomenon is especially useful when a plurality of components is attached to a board over a certain area. If one skilled in the art wishes to remove just one of these components, the entire area can be heated to at least 180° C., and that one component can be removed without damaging the bonds of any of the other components. As long as no stress is applied to the composition used to adhere each of the other components to the board, the other components remain in place. Upon cooling to a temperature no greater than about 120° C., the composition regains physical integrity, and the other components no longer can be easily removed from the board, and once again are rigidly adhered to the board.

If the polyfunctional crosslinking resin and the monofunctional chain-extending diluent contain free-radical polymerizable moieties, at least one free-radical initiator is present in the composition. In some embodiments the at least one initiator comprises 0.1 wt % to about 5 wt % based on total weight of the composition.

As used herein, the term “free radical initiator” refers to any chemical species which, upon exposure to sufficient energy (e.g., light, heat, or the like), decomposes into two parts which are uncharged, but which each possess at least one unpaired electron. Exemplary free radical initiators contemplated for use in the practice of the present invention include peroxides (e.g., dicumyl peroxide, dibenzoyl peroxide, 2-butanone peroxide, tert-butyl perbenzoate, di-tert-butyl peroxide, 2,5-bis(tert-butylperoxy)-2,5-dimethylhexane, bis(tert-butyl peroxyisopropyl)benzene, and tert-butyl hydroperoxide), and the like.

The term “free radical initiator” also includes photoinitiators. For example, for invention adhesive compositions that contain a photoinitiator, the curing process can be initiated by UV radiation. In one embodiment, the photoinitiator is present at a concentration of 0.01 wt % to 8 wt % based on the total weight of the composition. In a one embodiment, the photoinitiator comprises 0.1 wt % to 3.0 wt %, based on the total weight of the composition. Photoinitiators include benzoin derivatives, benzilketals, α,α-dialkoxyacetophenones, α-hydroxyalkylphenones, α-aminoalkylphenones, acylphosphine oxides, titanocene compounds, combinations of benzophenones and amines or Michler's ketone, and the like.

Inhibitors for free-radial cure may also be added to the invention compositions described herein to extend the useful shelf life of the compositions. Examples of these inhibitors include hindered phenols such as 2,6-di-tert-butyl-4-methylphenol; 2,6-di-tert-butyl-4-methoxyphenol; tert-butyl hydroquinone; tetrakis(methylene(3,5-di-tert-butyl-4-hydroxyhydrocinnamate))benzene; 2,2′-methylenebis(6-tert-butyl-p-cresol); and 1,3,5-trimethyl-2,4,6-tris(3′,5′-di-tert-butyl-4-hydroxybenzyl)benzene. Other useful hydrogen-donating antioxidants include derivatives of p-phenylenediamine and diphenylamine. It is also well know in the art that hydrogen-donating antioxidants may be synergistically combined with quinones, and metal deactivators to make a very efficient inhibitor package. Examples of suitable quinones include benzoquinone, 2-tert butyl-1,4-benzoquinone; 2-phenyl-1,4-benzoquinone; naphthoquinone, and 2,5-dichloro-1,4-benzoquinone. Examples of metal deactivators include N,N′-bis(3,5-di-tert-butyl-4-hydroxyhydrocinnamoyl)hydrazine; oxalyl bis(benzylidenehydrazide); and N-phenyl-N′-(4-toluenesulfonyl)-p-phenylenediamine. Nitroxyl radical compounds such as TEMPO (2,2,6,6-tetramethyl-1-piperidnyloxy, free radical) are also effective as inhibitors at low concentrations. The total amount of antioxidant plus synergists typically falls in the range of 100 to 2000 ppm relative to the weight of total base resin. Other additives, such as adhesion promoters, in types and amounts known in the art, may also be added.

A wide variety of fillers is contemplated for use in the practice of the present invention. In some embodiments, the fillers act primarily to modify the rheology of the resulting composition. The fillers may optionally be thermally conductive. Examples of suitable fillers which can be employed in the practice of the present invention include aluminum nitride, silicon carbide, boron nitride, diamond dust, alumina, and the like. Compounds which act primarily to modify rheology include polysiloxanes (such as polydimethyl siloxanes) silica, calcium carbonate, fumed silica, alumina, titania, and the like. When the filler is silica, the silica has a particle size in the range of about 1 μm up to about 100 μm.

In another embodiment of the invention, there are provided underfill compositions including a polyfunctional epoxy resin, a monofunctional epoxy diluent, and a catalyst, wherein the underfill composition is reworkable through loss of physical integrity when exposed to temperature conditions in excess of those used to cure the composition, and wherein the composition regains physical integrity when exposed to temperatures no greater than temperatures used to cure the composition.

In some embodiments, the polyfunctional epoxy resin includes a styrene-butacomponentne polymer backbone.

In other embodiments, the polyfunctional epoxy resin and/or the monofunctional epoxy diluent is a glycidyl ether of a phenol selected from a phenyl glycidyl ether, a cresyl glycidyl ether, a nonylphenyl glycidyl ether, or a p-tert-butylphenyl glycidyl ether, a diglycidyl ether of a bisphenol selected from bisphenol A, bisphenol F, ethylidinebisphenol, dihydroxydiphenyl ether, N,N′-disalicylal-ethylenediamine, arin, bis(4-hydroxyphenyl)sulfone, bis(hydroxyphenyl)sulfide, 1,1-bis(hydroxyphenyl)cyclohexane, 9,19-bis(4-hydroxyphenyl)fluorene, 1,1,1-tris(hydroxyphenyl)ethane, trihydroxytritylmethane, 4,4′-(1-alpha-methylbenzylidene)bisphenol, 4,4′-(1,3-componentthylethylene)diphenol, componentthylstilbesterol, 4,4′-dihyroxybenzophenone, resorcinol, catechol, or tetrahydroxydiphenyl sulfide, a glycidyl ether of a cresol formaldehyde,

a glycidyl ether of a fused ring polyaromatic phenol selected from dihydroxy naphthalene, 2,2′-dihydroxy-6,6′-dinaphthyl disulfide, or 1,8,9-trihydroxyanthracene a glycidyl ether of an aliphatic alcohol selected from a diglycidyl ether of 1,4 butanediol, a diglycidyl ether of neopentyl glycol, a diglycidyl ether of cyclohexane dimethanol, a trimethyol ethane triglycidyl ether, or a trimethyol propane triglycidyl ether, a glycidyl ether of a polyglycol selected from Heloxy 84.TM., Heloxy 32.TM., a polyglycidyl ether of castor oil, or a polyoxypropylene diglycidyl ether, a glycidyl ether of an aromatic amine, and the like.

A wide variety of acids are contemplated for use as the acidic fluxing agent. Typically, the acidic fluxing agent is a carboxylic acid such as, for example, 3-cyclohexene-1-carboxylic acid, 2-hexeneoic acid, 3-hexeneoic acid, 4-hexeneoic acid, acrylic acid, methacrylic acid, crotonic acid, vinyl acetic acid, tiglic acid, 3,3-dimethylacrylic acid, trans-2-pentenoic acid, 4-pentenoic acid, trans-2-methyl-2-pentenoic acid, 2,2-dimethyl-4-pentenoic acid, trans-2-hexenoic acid, trans-3-hexenoic acid, 2-ethyl-2-hexenoic acid, 6-heptenoic acid, 2-octenoic acid, (+/−)-citronellic acid, (R)-(+)-citronellic acid, (S)-(−)-citronellic acid, undecylenic acid, myristolic acid, palmitoleic acid, oleic acid, elaidic acid, cis-11-eicosenoic acid, erucic acid, nervonic acid, cis-3-chloroacrylic acid, trans-3-chloroacrylic acid, 2-bromoacrylic acid, 2-(trifluoromethyl)acrylic acid, 2-(bromomethyl)acrylic acid, 2-cyclopentene-1-acetic acid, (1R-trans)-2-(bromomethyl)-2-methyl-3-methylenecyclopentaneacetic acid, 2-acetamidoacrylic acid, 5-norbornene-2-carboxylic acid, 3-(phenylthio)acrylic acid, trans-styrylacetic acid, trans-cinnamic acid, alpha-methylcinnamic acid, alpha-phenylcinnamic acid, 2-(trifluoromethyl)cinnamic acid, 2-chlorocinnamic acid, 2-methoxycinnamic acid, cis-2-methoxycinnamic acid, 3-methoxycinnamic acid, 4-methylcinnamic acid, 4-methoxycinnamic acid, 2,5-dimethoxycinnamic acid, 3,4-(methylenedioxy)cinnamic acid, 2,4,5-trimethoxycinnamic acid, 3-methylindene-2-carboxylic acid, and trans-3-(4-methylbenzoyl)acrylic acid, oxalic acid, malonic acid, methylmalonic acid, ethylmalonic acid, butylmalonic acid, dimethylmalonic acid, componentthylmalonic acid, succinic acid, methylsuccinic acid, 2,2-dimethylsuccinic acid, 2-ethyl-2-methylsuccinic acid, 2,3-dimethylsuccinic acid, meso-2,3-dimethylsuccinic acid, glutaric acid, (+/−)-2-methylglutaric acid, 3-methylglutaric acid, 2,2-dimethylglutaric acid, 2,4-dimethylglutaric acid, 3,3-dimethylglutaric acid, adipic acid, 3-methyladipic acid, (R)-(+)-3-methyladipic acid, 2,2,5,5-tetramethylhexanedioic acid, pimelic acid, suberic acid, azelaic acid, 1,10-decanedicarboxylic acid, sebacic acid, 1,11-undecanedicarboxylic acid, undecanedioic acid, 1,12-dodecanedicarboxylic acid, hexadecanedioic acid, docosanedioic acid, tetracosanedioic acid, tricarballylic acid, beta-methyltricarballylic acid, 1,2,3,4-butanetetracarboxylic acid, itaconic acid, maleic acid, fumaric acid, citraconic acid, mesaconic acid, trans-glutatonic acid, trans-beta-hydromuconic acid, trans-traumatic acid, trans,trans-muconic acid, cis-aconitic acid, trans aconitic acid, (+/−)-chlorosuccinic acid, (+/−)-bromosuccinic acid, meso-2,3-dibromosuccinic acid, hexa fluoroglutaric acid, perfluoroadipic acid hydrate, dibromo-maleic acid, DL-malic acid, D-malic acid, L-malic acid, (R)-(−)-citramalic acid, (S)-(+)-citramalic acid, (+/−)-2-isopropylmalic acid, 3-hydroxy-3-methylglutaric acid, ketomalonic acid monohydrate, DL-tartaric acid, L-tartaric acid, D-tartaric acid, mucic acid, citric acid, citric acid monohydrate, dihydroflumaric acid hydrate, tetrahydrofuran-2,3,4,5-tetracarboxylic acid, mercaptosuccinic acid, meso-2,3-dimercaptosuccinic acid, thiodiglycolic acid, 3,3′-thiodipropionic acid, 3,3′-dithiodipropionic acid, 3-carboxypropyl disulfide, (+/−)-2-(carboxymethylthio) succinic acid, 2,2′,2″,2′″-[1,2-ethanediylidenetetrakis(thio)]-tetrakisacetic acid, nitromethanetrispropionic acid, oxalacetic acid, 2-ketoglutaric acid, 2-oxoadipic acid hydrate, 1,3-acetonedicarboxylic acid, 3-oxoadipic acid, 4-ketopimelic acid, 5-oxoazelaic acid, chelidonic acid, 1,1-cyclopropanedicarboxylic acid, 1,1-cyclobutanedicarboxylic acid, (+/−)-trans-1,2-cyclobutanedicarboxylic acid, trans-DL-1,2-cyclopentanedicarboxylic acid, 3,3-tetramethyleneglutaric acid, (1R.3S)-(+)-camphoric acid, (1S.3R)-(−)-camphoric acid, (+/−)-cyclohexylsuccinic acid, 1,1-cyclohexanediacetic acid, (+/−)-trans-1,2-cyclohexanedicarboxylic acid, (+/−)-1,3-cyclohexanedicarboxylic acid, trans-1,2-cyclohexanedicarboxylic acid, 1,4-cyclohexanedicarboxylic acid, 1,3-adamantanedicarboxylic acid, 3-methylenecyclopropane-trans-1,2-dicarboxylic acid, cis-5-norbornene-endo-2,3-dicarboxylic acid, 1,3,5-cyclohexanetricarboxylic acid, 1,3,5-cyclohexanetricarboxylic acid, kemp's triacid, (1alpha.3alpha.5beta)-1,3,5-trimethyl-1,3,5-cyclohexanetricarboxylic acid, 1,2,3,4-cyclobutane-tetracarboxylic acid, and 1,2,3,4,5,6-cyclo-hexanehexacarboxylic acid monohydrate, phenylmalonic acid, benzylmalonic acid, phenylsuccinic acid, 3-phenylglutaric acid, 1,2-phenylenediacetic acid, homophthalic acid, 1,3-phenylenediacetic acid, 4-carboxyphenoxyacetic acid, 1,4-phenylenediacetic acid, 2,5-dihydroxy-1,4-benzenediacetic acid, 1,4-phenylenediacrylic acid, phthalic acid, isophthalic acid, 1,2,3-benzenetricarboxylic acid hydrate, terephthalic acid, 1,2,4-benzenetricarboxylic acid, 1,2,4,5-benzenetetracarboxylic acid, mellitic acid, 3-(carboxymethylaminomethyl)-4-hydroxybenzoic acid, 4-methylphthalic acid, 2-bromoterephthalic acid, 4-bromoisophthalic acid, 4-hydroxyisophthalic acid, 4-nitrophthalic acid, nitrophthalic acid, 1,4-phenylenedipropionic acid, 5-tert-butylisophthalic acid, 5-hydroxyisophthalic acid, 5-nitroisophthalic acid, 5-(4-carboxy-2-nitrophenoxy)-isophthalic acid, diphenic acid, 4,4′-biphenyldicarboxylic acid, 5,5′dithiobis(2-nitrobenzoic acid), 4-[4-(2-carboxybenozoyl)phenyl]-butyric acid, pamoic acid, 1,4-naphthalenedicarboxylic acid, 2,3-naphthalenedicarboxylic acid, 2,6-naphthalenedicarboxylic acid, 1,4,5,8-naphthalene-tetracarboxylic acid hydrate, 2,7-di-tert-butyl-9,9-dimethyl-4,5-xanthenedicarboxylic acid, and the like.

A particularly useful carboxylic acid for the preparation of the latent fluxing agents of the present invention is DIACID 1550®, a monocyclic C₂₁ dicarboxylic acid product derived from tall oil fatty acids, commercially available from Westvaco Corporation.

Optionally, a coupling agent may be incorporated into the invention underfill compositions. As used herein, the term “coupling agent” refers to chemical species that are capable of bonding to a mineral surface and which also contain polymerizably reactive functional group(s) so as to enable interaction with the adhesive composition. Coupling agents thus facilitate linkage of the underfill composition to the board to which it is applied.

In some embodiments, both photoinitiation and thermal initiation may be desirable. For example, curing of a photoinitiator-containing adhesive can be started by UV irradiation, and in a later processing step, curing can be completed by the application of heat to accomplish a free-radical cure. Both UV and thermal initiators may therefore be added to the underfill composition.

In general, the underfill compositions of the invention will cure within a temperature range of 80-120° C., and curing will be effected within a length of time of less than 1 minute to 60 minutes. Typically, underfill encapsulation takes place simultaneously with reflow of the solder interconnects. Thus, the underfill compositions described herein, which include a fluxing agent if solder is the interconnect material, first is applied to either the board or the component; then terminals on the component and board are aligned and contacted and the assembly heated to reflow the metallic or polymeric interconnect material. During this heating process, curing of the underfill composition occurs simultaneously with reflow of the metallic or polymeric interconnect material. As will be understood by those skilled in the art, the time and temperature curing profile for each underfill composition will vary, and different compositions can be designed to provide the curing profile that will be suited to the particular industrial manufacturing process.

In certain embodiments, the underfill compositions may contain compounds that lend additional flexibility and toughness to the resultant cured composition. Such compounds may be any thermoset or thermoplastic material having a Tg of 50° C. or less, and typically will be a polymeric material characterized by free rotation about the chemical bonds, the presence of ether groups, and the absence of ring structures. Suitable such modifiers include polyacrylates, poly(butacomponentne), polyTHF (polymerized tetrahydrofuran, also known as poly(1,4-butanediol)), CTBN (carboxy-terminated butacomponentne-acrylonitrile) rubber, and polypropylene glycol.

Suitable curing agents contemplated for use with the epoxy-based invention underfill composition include phenols, polyphenols, anhydrides, and the like. Certain catalysts contemplated, include for example, compounds which can be employed to catalyze the reaction between a phenolic hydroxyl group and a vicinal epoxide group include, for example, tertiary amines such as, triethylamine, tripropylamine, tributylamine; 2-methylimidazole (such as, for example, the Curezol™ imidazoles available from Air Products), N-methylmorpholine, combinations thereof and the like; quaternary ammonium compounds such as, benzyl trimethyl ammonium chloride, tetrabutylammonium chloride, combinations thereof and the like; phosphines such as triphenylphosphine, tributylphosphine, trilaurylphosphine, trichlorobutylphosphine, trinaphthylphosphine, and the like; and phosphonium compounds such as, ethyltriphenylphosphonium chloride, ethyltriphenylphosphonium bromide, ethyltriphenylphosphonium iodide, ethyltriphenylphosphonium phosphate, ethyltriphenylphosphonium acetate.acetic acid complex, tetrabutylphosphonium chloride, tetrabutylphosphonium bromide, tetrabutylphosphonium iodide, tetrabutylphosphonium phosphate, tetrabutylphosphonium acetate.acetic acid complex, butyltriphenylphosphonium tetrabromobisphenate, butyltriphenylphosphonium bisphenate, butyltriphenylphosphonium bicarbonate, combinations thereof and the like.

In yet another embodiment of the invention, there are provided assemblies of components adhered together employing the above-described underfill compositions. Thus, for example, assemblies comprising a first article adhered to a second article by a cured aliquot of the above-described underfill compositions are provided. Articles contemplated for assembly employing invention compositions include memory devices, ASIC devices, microprocessors, flash memory devices, and the like. Also contemplated are assemblies including a microelectronic device adhered to a board by a cured aliquot of the above-described underfill compositions. Microelectronic devices contemplated for use with invention underfill compositions include silicon components, gallium arsenide components, germanium components, and the like.

In some embodiments, the board is organic, such as for example, polyamide, FR4, bismaleimide-triazine (BT), BT-glass, and the like.

In yet another embodiment of the invention, there are provided methods for reversibly attaching a device to a board. Such methods can be peformed, for example, by

(a) applying an aliquot of an invention composition to the device or board or both,
(b) bringing the device into contact with the board to form an assembly, wherein the device and the board are separated only by the adhesive composition applied in (a),
(c) subjecting the assembly to temperature conditions suitable to cure the adhesive composition, thereby adhering the device to the board,
(d) subjecting the assembly to temperature conditions suitable to remove physical integrity of the adhesive composition, and
(e) applying stress to the adhesive composition so that the adhesive composition forms a powder, wherein adhesion between the device and board is lost, thereby reversibly attaching the device to the board.

In another embodiment of the invention, there are provided methods for reversibly attaching a device having at least one solderable contact to a board. Such methods can be performed, for example, by

a) contacting the device with the board via the at least one solderable contact, thereby forming an electronic assembly;

b) providing an invention underfill composition between the device and the board;

c) subjecting the assembly to a temperature sufficient to reflow the solderable contacts and cure the underfill composition, thereby adhering the device to the board,

(d) subjecting the assembly to temperature conditions suitable to remove physical integrity of the adhesive composition, and

(e) applying stress to the adhesive composition so that the adhesive composition forms a powder, wherein adhesion between the device and board is lost, thereby reversibly attaching a device having at least one solderable contact to a board.

The invention will now be further described with reference to the following non-limiting example.

### EXAMPLE

In this example, the polyfunctional epoxy resin is Epon™ 872 (Hexion Corp.) (63.75%), the monofunctional epoxy diluent is Heloxy™ 68 (21.25%) (Hexion Corp.) and the curing agent is 862/2MZ azine (prepared by milling 2M-azine (Air Products) into Epon 862 (Hexion)) (15.00%). The initial viscosity was 30,000 CPS and the H reaction was 222 J/g. Additional Heloxy™ 68 was added until the viscosity was reduced to 6000 cps. The heat of reaction was found to be <250 J/g. It was found that this material lost its physical integrity, i.e., became reworkable, at 200° C.

While the invention has been described with respect to this specific example, it should be clear that other modifications and variations are possible without departing from the spirit of the invention.

What is claimed is:

1. A reworkable composition comprising a polyfunctional crosslinking resin and a monofunctional chain-extending diluent, wherein the composition is reworkable through loss of physical integrity when exposed to temperature conditions in excess of those used to cure the composition, and wherein the composition regains physical integrity when exposed to temperatures no greater than temperatures used to cure the composition.

2. The composition of claim 1, wherein the composition loses physical integrity at a temperature of at least 180° C.

3. The composition of claim 1, wherein the composition regains physical integrity at a temperature no greater than about 120° C.

5. The composition of claim 1, further comprising at least one curing initiator.

6. The composition of claim 5, wherein the at least one curing initiator comprises 0.1 wt % to about 5 wt % based on total weight of the composition.

7. The composition of claim 1, further comprising a filler.

8. The composition of claim 7, wherein the filler is silica.

9. The composition of claim 8, wherein the silica has a particle size in the range of about 1 μm up to about 100 μm.

10. The composition of claim 1, wherein the polyfunctional ccrosslinking resin is selected from itaconate, maleimide, acrylate, methacrylate, epoxy, vinyl ester, vinyl ether, styrenic, maleate, fumarate, acrylamide, methacrylamide, oxazoline, or benzoxazine.

11. The composition of claim 1, wherein the monofunctional chain-extending diluent is selected from itaconate, maleimide, acrylate, methacrylate, epoxy, vinyl ester, vinyl ether, styrenic, maleate, fumarate, oxazoline, or benzoxazine.

12. A underfill composition comprising a polyfunctional epoxy resin, a monofunctional epoxy diluent, and a catalyst, wherein the underfill composition is reworkable through loss of physical integrity when exposed to temperature conditions in excess of those used to cure the composition, and wherein the composition regains physical integrity when exposed to temperatures no greater than temperatures used to cure the composition.

13. The underfill composition of claim 12, wherein the polyfunctional epoxy resin comprises a styrene-butacomponentne polymer backbone.

14. The underfill composition of claim 12 further comprising an acidic fluxing agent.

15. The underfill composition of claim 14, wherein the acidic fluxing agent comprises a carboxylic acid.

16. The underfill composition of claim 14, wherein the acidic fluxing agent comprises a dicarboxylic acid.

17. A method for reversibly attaching a device to a board, comprising:
(a) applying an aliquot of the adhesive composition of claim 1 to the device or board or both,
(b) bringing the device into contact with the board to form an assembly, wherein the device and the board are separated only by the adhesive composition applied in (a),
(c) subjecting the assembly to temperature conditions suitable to cure the adhesive composition, thereby adhering the device to the board,
(d) subjecting the assembly to temperature conditions suitable to remove physical integrity of the adhesive composition, and
(e) applying stress to the adhesive composition so that the adhesive composition forms a powder, wherein adhesion between the device and board is lost, thereby reversibly attaching the device to the board.

18. A method for reversibly attaching a device having at least one solderable contact to a board, comprising
(a) contacting the device with the board via the at least one solderable contact, thereby forming an electronic assembly;
(b) providing the underfill composition of claim 12 between the device and the board;
(c) subjecting the assembly to a temperature sufficient to reflow the solderable contacts and cure the underfill composition,
(d) subjecting the assembly to temperature conditions suitable to remove physical integrity of the adhesive composition, and
(e) applying stress to the adhesive composition so that the adhesive composition forms a powder, wherein adhesion between the device and board is lost, thereby reversibly attaching a device having at least one solderable contact to a board.
